(19) United States
(12) Patent Application Publication
(10) Pub. No.: US 2012/0278235 A1
(43) Pub. Date: Nov. 1, 2012

(54) Electronic Envelope Budget Planning and Control System

(76) Inventor: Audrey E. Kitchel, Lafayette, IN (US)

(21) Appl. No.: 13/097,381

(22) Filed: Apr. 29, 2011

(51) Int. Cl. G06Q 40/00

(52) U.S. Cl. 705/44

(57) ABSTRACT

Described herein is a method of implementing an electronic envelope budget planning and control system. Such a system includes establishing sub-accounts which have criteria limiting consumer spending of such sub-accounts substantially simultaneously with purchasing transactions by requiring funding of a transaction to meet budgeting criteria and funding limits before such a transaction can be funded at the point of sale.

### BACKGROUND OF THE INVENTION

### Cross-Reference to Related Applications

Not applicable.

### STATEMENT REGARDING FEDERALLY SPONSORED RESEARCH OR DEVELOPMENT

Not applicable.

### BACKGROUND OF THE INVENTION

Being able to manage money is a vital skill necessary for anyone who wants to establish or maintain financial independence. However the discipline needed to effectively manage money can be difficult to master. With advertising and marketing experts trying to take advantages of shopper's impulses at every retail store front or point of sale, staying within a budget can be difficult.

A trusted method of budgeting that has been used for years involves separating funds into budget categories and placing each category into a separate envelope. When the envelope is empty it is clear that no more spending should occur in that category. Many financial systems today offer a similar approach of categorizing transactions once they are recorded by the system so that consumers can track their spending in the various categories. However, this tracking after the fact does little to help if you have already overspent a category.

### BRIEF DESCRIPTION OF THE DRAWINGS

FIG. 1 illustrates an environment for implementing an electronic envelope budget planning and control system in accordance with an exemplary embodiment of the invention.

FIG. 2 illustrates an exemplary basic structure of a record system for implementing an electronic envelope budget planning and control system in accordance with an exemplary embodiment of the invention.

FIG. 3 illustrates a flow diagram for managing an electronic envelope budget planning and control system in accordance with an exemplary embodiment of the invention.

FIG. 4 illustrates a flow diagram for completing transactions funded by an electronic envelope budget planning and control system in accordance with an exemplary embodiment of the invention.

### DETAILED DESCRIPTION OF THE PREFERRED EMBODIMENTS

Herein is described a budgeting and control system designed to be used with existing banking systems which consist of checking and/or debit accounts. The system described permits the consumer to virtually place their money in envelopes or sub-accounts for budgeting and control purposes. A portion of the funds may be placed in the main account and thus is not allocated to a specific budget category. A portion of the funds may be placed in one or more sub-accounts thus marking it for use to meet expenditures of a certain category. One or more of these sub-accounts may be sealed or locked such that they cannot be accessed unless certain conditions are met.

When a consumer makes a deposit they may designate portions of the funds to be deposited into each of the sub-accounts, or they may place all funds in a main account, and then transfer the funds to sub-accounts through a more convenient interface such as those found in a modern online banking system or an electronic accounting system. When sub-accounts are managed, a consumer may designate the rules for accessing sub-accounts.

In one embodiment a sub-account may be designated as only being accessible after a certain period of time. For example, a consumer who is paid once a month may designate that half their pay is held in a sealed sub-account until the second half of the month thus ensuring they have funds for the entire month. In another example, a consumer who has a seasonal income stream may designate all deposits into a sub-account which is configured to only make a fixed amount accessible each month for transfer to other sub-accounts, thus providing a steady financial situation throughout the year. In another instance, a consumer may designate a certain amount to be placed in a sealed sub-account each month to meet larger infrequent expenses such as bi-yearly car insurance premiums.

In another embodiment a consumer designates funds in a certain account to be used only for expenditures to a certain party. For example, a consumer may designate $X to be deposited into a locked sub-account each month which can only be used for payment to property taxes which may be due only once a year. In another example, a consumer may designate funds to be deposited into a sub-account each month for utilities, and designate which vendors are utilities. The system would then only use the sub-account's funds for transactions from the designated vendors and reject all transactions from a non-designated vendor. In another embodiment, rather than the consumer designating the vendor types, the vendors can be identified and classified by the bank, or a third-party, or they may be self-classifying.

In another embodiment a consumer designates a second party which must authorize an expenditure. For instance, a couple saving for a new home may place funds in a sealed account so that they must both authorize expenditures from the sub-account. In another example, a parent places funds in an account for a child away at college, and designates the funds as secured in sub-accounts. These sub-accounts may be sealed and designated such that the child's tuition sub-account only accepts charges from the school administration, and the bookstore, the meal sub-account only accepts charges from the cafeteria or food court, but the discretionary account is accessible for the child to use for gas, entertainment, etc by accepting charges from unlimited vendors. In this situation, the parent may have the authority to authorize expenditures or reclassify expenditures after the point of sale as a way of helping the child with budgeting and financing.

In another application issuers of Electronic Benefit Transfer (EBT) cards could categorize benefits into sub-accounts to ensure maximum benefit to the users and to guard against fraudulent spending. i.e. Food Stamps users would have certain amounts to spend on produce, grains, dairy products, meats, etc.

In another application businesses could assign certain envelopes (sub-accounts) for use by different sales persons to track and control travel and entertainment expenses.

In another application receipts for purchases made from envelopes might return the remaining balance for the particular envelope much in the same way one is often notified of remaining balances on a gift card.

In other implementations of electronic budgeting systems, a consumer may designate categories for charges after purchases are made so that expenditures can be tracked to budget categories. Such a system has no mechanism for ensuring one does not go over budget in a particular category, as the consumer may not be aware they are over budget until after the transaction is completed. Such a system allows a consumer to make discretionary spending choices which could result in insufficient funds to cover essential expenses.

In order to aid a consumer in adhering to a budget; the consumer, at the time of purchase, must designate purchases as being funded from specific sub-accounts. A charge designated to a sub-account which lacks sufficient funds is denied before the transaction completes thus requiring the consumer to make a conscious decision to use funds designated for other purposes or forgo the expenditure. Further with this system, the consumer can have unallocated funds which are discretionary and can be used to make up short-falls in any budget category. The consumer has multiple accounts which are all accessible from a single system so retail establishments are not burdened with the consumer paying from multiple funding sources as it all funnels through a single system.

The consumer can further designate accounts to accept charges from only certain retail vendors. Thus a person cannot spend their electricity payment funds on entertainment because the utilities sub-account only accepts charges from the utility companies, and rejects all others. In one embodiment, a consumer would have to designate the vendor's individually which are authorized to charge to a specific sub-account. As an example, the utility sub-account may be designated to only accept charges from the electric company, the telephone company, the cable company, and the water company, but would reject any charges from the local theater, bar, or sports arena. In another embodiment, a consumer could designate a category of vendors which are authorized to charge to a specific sub-account. Such a system would require a categorizing of vendors. This could be done automatically based on SIC codes or other national designations as to the type of business, or it could be done manually by the administrators of the system.

As not all retailers would immediately have the facilities in place to utilize such a system as described here, as an alternative, the system can require all transactions, where the consumer is unable to designate sub-accounts, to be funded from non-designated funds. The consumer could then access the system and reclassify any transactions to a designated sub-account thus replenishing the available non-designated funds for further non-classified transactions.

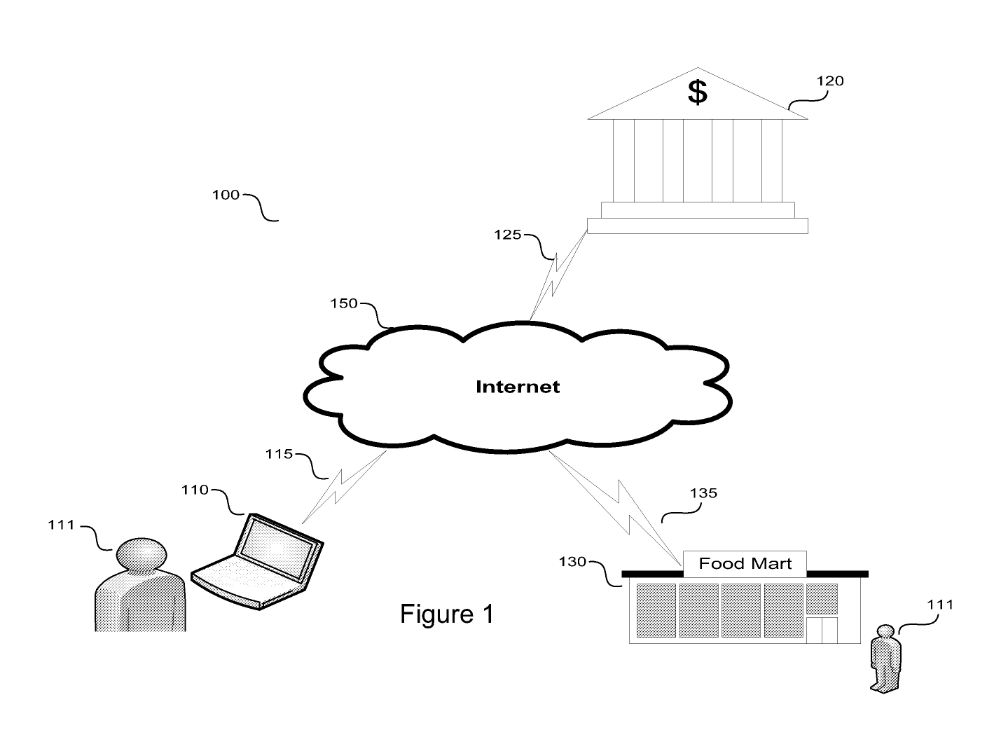

FIG. 1 illustrates an environment (100) for implementing an electronic envelope budget planning and control system. In this environment, a financial institution (120) maintains a record of a plurality of accounts for a consumer (111) which is accessible by a terminal (110) through remote connections (115, 125) which may be a part of the Internet (150). Retail establishments (130) may allow consumers (111) to utilize electronic funds to pay for services through point of sale terminals (not illustrated), through a remote connection (135) which may be a part of the Internet (150).

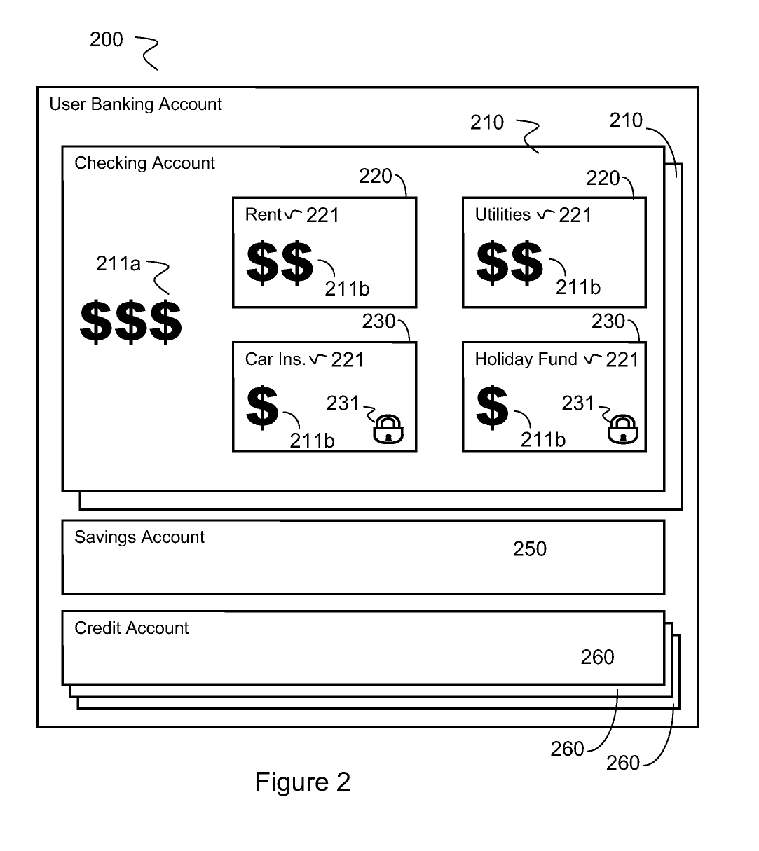

FIG. 2 illustrates an exemplary basic structure of a record system for implementing an electronic envelope budget planning and control system. The financial institution maintains a record (200) of customer funds, which may include but not be limited to one or more checking accounts (210), Savings Accounts (250), and/or Credit Accounts (260). These accounts may be individually managed, or as a group of total available funds. In another embodiment, the accounts could be from a plurality of financial institutions and the record (200) of customer funds is managed by a central entity which may function as a clearinghouse for transactions. The managed groups are divided into a plurality of sub-accounts (220, 230) which are then given designations (221) as to what the purpose of the funds. Some of these accounts (230) are designated as sealed accounts (231); which ensures that the funds can only be accessed in ways that meet certain restrictions specified by the consumer. Funds may be allocated to the sub-accounts (211b) to meet the expenditures allocated to the sub-account (220, 230). Some funds may remain unallocated (211a). Such unallocated funds (211a) are available for expenses that are not designated to a sub-account (220, 230), or for expenses which exceed the funds (211b) allocated to those sub-accounts (220, 230). Such unallocated funds (211a) may also be used as a temporary funding source for transactions that are to later be classified by the consumer into one or more sub-accounts (220, 230).

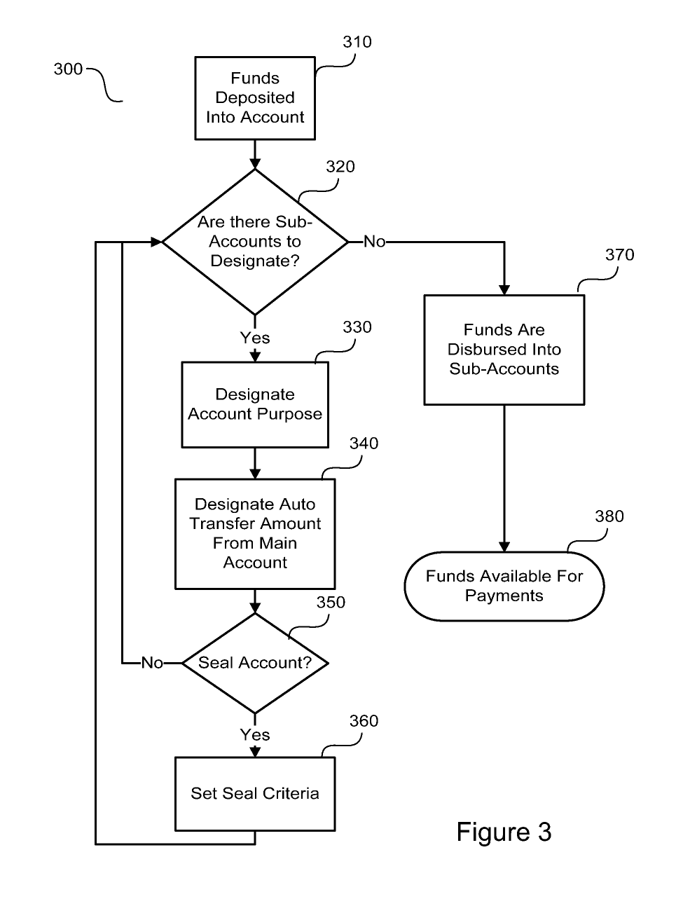

FIG. 3 illustrates a flow diagram (300) of the procedure one would follow to manage the electronic envelope budget planning and control system when depositing and budgeting. Funds should exist in an account for budgeting, however budgets can be established, and categories can be specified even if no funds are being deposited. For illustrative purposes the following descriptions will presume funds are being deposited. Funds are deposited into an account (310) to be managed. The consumer then determines if there are sub-accounts to designate (320). In some instances the sub-accounts may already be established from previous activities and adjustment may not be necessary during a particular session. If there are sub-accounts to be designated (320) or adjustments to be made on accounts that are already designated, then that should occur before funds are disbursed into Sub-Accounts (370).

Designating an account consists of creating the account and designating the purpose (330) for the account. Auto transfers can be established from the main account (340). These may be in the form of automatic transfers which occur on a timely basis, such as but not limited to monthly, weekly, bi-weekly. Further, auto transfers may be pre-established transfers which are triggered by certain events. In one embodiment the transfer may be for a pre-set amount to be transferred when a balance reaches or passes a certain level, for example, if there is ever more than $3,000 in the account, transfer the excess to a savings account. In another embodiment the transfer may be for a percentage to be transferred, for example, transfer five percent (5%) of every deposit exceeding one hundred dollars ($100.00) to a retirement account.

Once an account has been established and funded, a decision must be made to seal the account (350). If an account is to be sealed, then criteria must be set for the unsealing of the account (360). Sealing an account makes it more difficult for a consumer to move funds from the account, and/or prevents expenditures which may exceed an accounts funding.

In one embodiment, an account may be sealed such that two people must both enter a pin before transactions from that account are accepted. In one embodiment, a person making a transaction may designate a sub-account to fund the transfer. A second authorizer must respond with approval before the transaction can be finally authorized. In one embodiment the secondary authorizer must be present at the time of the transaction to make the secondary authorization. In another embodiment, a consumer may be required to designate a secondary account to be used if the secondary authorizer fails to authorize the transaction. A message requesting authorization is then sent to the secondary authorizer and their response determines the actions to proceed. In another embodiment, a transaction may remain pending until the secondary authorization is received. In such a situation the failure of a secondary authorization may simply terminate the transaction and thus no secondary sub-account is necessary.

In another embodiment, a sub-account would only accept transactions from particular sources. As an example, a “utilities” sub-account may be sealed such that its funds can only be used to make payments to an electric company, a phone company, a water company, etc., but payments to a grocery store or department store would not be allowed.

Once funds are deposited into an account (310), and there are no more sub-account designations (320) or modifications to be made, funds can be disbursed into the sub-accounts (370). This may be in the form of automatic disbursements, such as those designated for each sub account (340), they may be manual transfers, or a combination. Once the transfers are completed, Funds are available for payments (380).

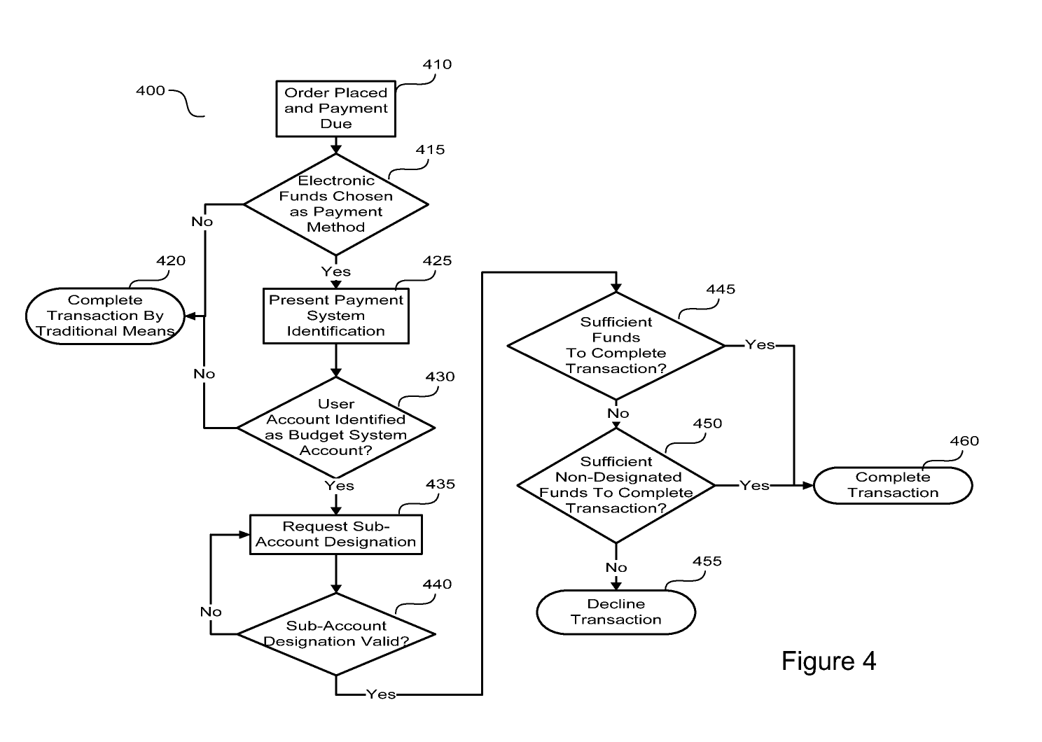

FIG. 4 illustrates a flow diagram (400) of the procedure one would follow at the point of sale to complete a transaction funded by the electronic envelope budget planning and control system. Once an order is placed and payment is due (410), a method of payment must be chosen (415). If the method of payment is not through electronic funds, then the transaction is completed by traditional means (420). If electronic funds are chosen as the payment method (415), then the consumer must present payment system identification (425). This is typically a credit card, log-in credentials, or some other means of identifying the account, financial institution, and person.

Once the account has been identified and proper access has been established; it can be determined if the account is a traditional account, or an account which uses the budgeting system (430). If it is a traditional account, then the transaction is completed by traditional means (420). If the account is a budget system account (430), then a sub-account designation should be determined (435). In one embodiment, the consumer would use a code to designate the sub-account. This code could be in the form of a numeric sub-account id which may be sent as a part of the initial account identification (425). This numeric sub-account id coupled with the main account id uniquely designates the funding source. In another embodiment, a list of sub-accounts may be provided by the financial institution and the customer would then pick from the list presented.

The sub-account designation provided by the consumer must be verified against the financial institution records to determine if it is a valid sub-account designation (440). If it is not a valid sub-account designation, then the consumer may be given another opportunity to enter a different sub-account designation (435). As an alternative, the transaction may simply be denied at that point.

Once a proper sub-account has been established, the system would then determine if there are sufficient funds to complete the transaction (445). If there are sufficient funds, then the transaction is completed (460), and the funds are deducted from the sub-account balance and the transaction is registered in the system.

If there are insufficient funds in the sub-account to complete the transaction (445), then depending on the settings of the sub-account, the system may use funds from non-designated funds (FIG. 2, 211a) to complete the transaction (450). The consumer may have designated that this is not to happen when they set up the sub-account as part of the seal criteria (FIG. 3, 360). If there are insufficient funds from the sub-account either with or without supplementation from the non-designated funds, then the transaction may be declined (455).

The flow diagrams in accordance with exemplary embodiments of the present invention are provided as examples and should not be construed to limit other embodiments within the scope of the invention. For instance, the blocks should not be construed as steps that must proceed in a particular order. Additional blocks/steps may be added, some blocks/steps removed, or the order of the blocks/steps altered and still be within the scope of the invention. Further, blocks within different figures can be added to or exchanged with other blocks in other figures. Further yet, specific numerical data values (such as specific quantities, numbers, categories, etc.) or other specific information should be interpreted as illustrative for discussing exemplary embodiments. Such specific information is not provided to limit the invention.

The diagrams in accordance with exemplary embodiments of the present invention are provided as examples and should not be construed to limit other embodiments within the scope of the invention. For instance some elements illustrated in the singularity may actually be implemented in a plurality. Further, some element illustrated in the plurality could actually vary in count. Further, some elements illustrated in one form could actually vary in detail. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory (such as memory of the handheld portable electronic device) and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method of managing financial resources comprising;
allocating portions of total funds in an account to individual sub-accounts;
tracking spending by managing which sub-account the funds are to be deducted from; and
preventing spending beyond the allocated portions allocated to a particular sub-account.

2. A method, as described in claim 1 wherein allocating further comprises:
allocating portions of total funds from a plurality of accounts to individual sub-account which may span multiple accounts.

3. A method, as described in claim 1 wherein tracking spending further comprises:
designating a sub-account for funding a transaction substantially simultaneously to the transaction occurrence.

4. A method, as described in claim 3 wherein designating a sub-account further comprises:
appending a sub-account identifier to the account identifier.

5. A method, as described in claim 4 wherein designating a sub-account occurs at a retail point of sale.

6. A method, as described in claim 1 wherein preventing spending beyond the allocated portions further comprises:
designating a sub-account as sealed.

7. A method, as described in claim 6 wherein preventing spending beyond the allocated portions further comprises:
rejecting transactions that designate a sub-account for funding a transaction which is a sealed sub-account.

8. A method, as described in claim 6 wherein sealing an account further comprises:
designating a method of unsealing a sub-account at the time of sealing the sub-account.

9. A method, as described in claim 8 wherein unsealing an account further comprises marking an electronic control to designate the account is sealed or unsealed.

10. A method, as described in claim 9 wherein unsealing an account further comprises answering a security question successfully before an account is sealed or unsealed.

11. A method, as described in claim 8 wherein the method of unsealing a sub-account comprises waiting for a specific predetermined amount of time.

12. A method, as described in claim 8 wherein the method of unsealing a sub-account comprises requiring authorization from a plurality of individuals.

13. A method, as described in claim 8 wherein the method of unsealing a sub-account comprises waiting for the sub-account to reach or exceed a specific balance.

14. A method, as described in claim 1 wherein the account is a banking account at a financial institution.

15. A method, as described in claim 1 wherein the account is a credit account at a financial institution.

16. A method, as described in claim 13 wherein the total funds comprises a line of credit.

17. A system for completing a financial transaction near the point of sale comprising:
designating an institution for funding the transaction;
designating an account at the institution;
designating a sub-account of the account;
confirming authorization from the institution before finally approving the transaction; and
receiving a rejection from the authorized institution if a sub-account is sealed or underfunded.

18. A method, as described in claim 17 wherein the method of designating a sub-account comprises:
presenting a list of all sub-accounts for a given account;
choosing a sub-account from the list presented.

19. A method, as described in claim 17 wherein the method of designating a sub-account comprises:
entering a sub-account identifier at the time of the transaction.
